(19) United States
(12) Patent Application Publication
(10) Pub. No.: US 2006/0034977 A1
(43) Pub. Date: Feb. 16, 2006

(54) Method for processing okara

(76) Inventors: Ilan Rotem, Lapid (IL); Nava Almog, Ra'anana (IL)

Correspondence Address: NATH & ASSOCIATES, 112 South West Street, Alexandria, VA, 22314, US

(21) Appl. No.: 10/918,738

(22) Filed: Aug. 16, 2004

(51) Int. Cl. A23B 7/148

(52) U.S. Cl. 426/106

(57) ABSTRACT

The invention provides a method for processing okara comprising cooling the okara and packaging the cooled okara in the absence of oxygen. The invention also provides a method for storing okara comprising cooling the okara, packaging the okara in the absence of oxygen and maintaining the okara at a cooled temperature and in the absence of oxygen. The invention further provides a food product comprising okara, the food product being a breakfast cereal, a granola, or a pasta.

### FIELD OF THE INVENTION

This invention relates to methods for processing plant products and more specifically to such methods for processing plant products for making an edible food product.

### BACKGROUND OF THE INVENTION

“Okara” is a by-product in the production of soy bean products such as soy “milk” and tofu. In the production of these soy bean products, soy beans are allowed to swell in water and are then pulverized to a colloidal paste. The paste is then heated and separated into water soluble and water insoluble fractions. The water soluble fraction is used to produce soy milk and tofu. The remainder of the paste is referred to as “okara”.

Tofu is widely accepted as a very nutritious and digestible food. Okara is also believed to be appreciably nutritious and digestible. However, okara quickly sours after its production rendering it unusable in a food product. Thus, okara is considered to be merely a waste product in the production of tofu, and is rarely used for the production of a food product for human consumption. It is usually either used as an animal feed or is simply discarded.

U.S. Pat. No. 5,128,165 to Wakana discloses a cake made from okara. Okara is dried and then milled into a powder. The okara powder is then mixed with baking powder and other ingredients and baked for about twenty minutes at 170° C.

U.S. Pat. No. 6,541,058 to Ezaki et al. discloses a method for processing wet okara, in which wet okara is finely divided and then fed into a scraper type heat exchanger heating at a temperature of at least 120° C. The okara is then cooled and sealed aseptically in a container or package. The okara may be sterilized by saturated steam at a pressure of 8 kg/cm².

### DESCRIPTION OF THE INVENTION

In its first aspect, the present invention provides a method for processing okara in order to prevent souring. This aspect of the invention is based upon the unexpected discovery that okara that is cooled and then packaged in the absence of oxygen does not sour. Thus, this aspect of the invention provides a method for processing okara comprising cooling the okara and packaging the okara in the absence of oxygen. For example, the okara may be packaged under vacuum. As another example, the okara may be packaged in an environment in which air has been replaced with another gas, such as nitrogen, or with a mixture of gasses. The okara is preferably cooled to below 20° C., more preferably to below 10° C. and still more preferably to below 5° C. In a presently preferred embodiment, the okara is cooled to 4° C., subjected to a vacuum and maintained at 4° C. under vacuum until used. The packaged okara, when maintained at 4° C., does not sour. Okara processed and packaged in accordance with the invention may therefore be stored for prolonged periods of time without souring, so that the okara maintains its suitability for use in a food product for human consumption. Thus, in its second aspect, the invention provides a method for storing okara.

The okara to be processed by the method of the invention may be obtained by any known method for producing okara known in the art. For example, okara may be obtained by soaking soybeans that may be dehulled, or dehypocotylated or defatted and then pulverizing the soy beans. The insoluble okara is the separated from the water soluble “soy milk” with steam.

The inventors have found that okara processed in accordance with the invention may be used in the preparation of foodstuffs for human consumption, even after prolonged storage. Thus, in its fourth aspect, the invention provides an edible food product comprising okara such as a breakfast cereal or a pasta.

Thus, in one of its aspects, the invention provides a method for processing okara comprising cooling the okara and packaging the cooled okara in the absence of oxygen.

In another of its aspects, the invention provides a method for storing okara comprising:
(a) cooling the okara;
(b) packaging the okara under vacuum; and
(c) maintaining the okara at a cooled temperature and in the absence of oxygen.

In yet another of its aspects, the invention provides a food product comprising okara, the food product being a breakfast cereal, a granola, or a pasta.

### EXAMPLES

### Example 1

### Soy Flakes Breakfast Cereal

250 gr. soy flour, 14 gr. baking powder and 50 gr. gluten were combined. 700 gr. okara processed in accordance with the invention was then added and the dough kneaded to a uniform texture. The dough was crumbled into small pieces which were then rolled into thin flakes. The flakes were then put in a 140° C. oven for about 30 minutes. The resulting product may be eaten as a breakfast cereal.

### Example 2

### Sweetened Breakfast Cereal

250 gr. soy flour, 14 gr. baking powder and 50 gr. gluten were combined. 700 gr. okara processed in accordance with the invention and a sweetener (30 gr. table sugar or an equivalent amount of a heat stable artificial sweetener such as saccharine) were then added and the dough kneaded to a uniform texture. The dough was crumbled into small pieces which were then rolled into thin flakes. The flakes were then put in a 140° C. oven for about 45 minutes. The resulting product may be eaten as a breakfast cereal.

### Example 3

### Soy “Granola™”

350 gr okara processed in accordance with the invention, 50 gr. shredded coconut, 30 gr. bleached almonds, 50 gr. sunflower seeds, 30 gr. pumpkin seeds and 50 gr. sesame seeds were mixed together. In a separate container, 100 gr. date syrup, 150 gr. honey or maple syrup, 100 ml. sunflower oil and 100 ml. sesame oil were mixed. The two mixtures were then combined and the mixture brought to a uniform texture. The mixture was pressed on the bottom of a baking tray that is either oiled, Teflon™ coated, or lined with baking paper, and then placed in a 140° C. oven for 45 minutes. The baked mixture is allowed to cool and is then crumbled into small pieces. A cup of chopped dried fruit (raisins, apples, pineapple, papaya, apricot and prunes) was then added to the crumbled mixture.

### Example 4

### Pasta

Flour such as semolina flour (57% by weight), gluten (3%), calcium bicarbonate (0.3%) and 90% soy protein isolate (4%) were mixed together. 35.7% okara, processed in accordance with the invention, was then added. The mixture was then shaped into the desired shape of the pasta pieces in an an extruder or press and then dried.

1. A method for processing okara comprising cooling the okara and packaging the cooled okara in the absence of oxygen.

2. The method according to claim 1 wherein the okara is cooled to below 20° C.

3. The method according to claim 2 wherein the okara is cooled to below 10° C.

4. The method according to claim 3 wherein the okara is cooled to below 4° C.

5. The method according to claim 1 wherein the okara is packaged under vacuum.

6. The method according to claim 1 wherein the okara is packaged in a gas other than oxygen or in a mixture of gasses not containing oxygen.

7. The method according to claim 6 wherein the okara is packaged in nitrogen or in a mixture containing nitrogen.

8. Okara processed by the method of claim 1.

9. A food product containing the okara according to claim 8.

10. The food product according to claim 9 being a breakfast cereal, a granola or a pasta.

11. A method for storing okara comprising:
(a) cooling the okara;
(b) packaging the okara in the absence of oxygen; and
(c) maintaining the okara at a cooled temperature and in the absence of oxygen.

12. The method according to claim 11 wherein the okara is cooled to below 20° C.

13. The method according to claim 11 wherein the okara is cooled to below 10° C.

14. The method according to claim 11 wherein the okara is cooled to below 4° C.

15. The method according to claim 11 wherein the okara is packaged under vacuum.

16. The method according to claim 11 wherein the okara is packaged in a gas other than oxygen or in a mixture of gasses not containing oxygen.

17. The method according to claim 16 wherein the okara is packaged in nitrogen or in a mixture containing nitrogen.

18. Okara stored by the method of claim 11.

19. A food product containing the okara according to claim 18.

20. The food product according to claim 19 being a breakfast cereal, a granola or a pasta.

21. A food product comprising okara, the food product being a breakfast cereal, a granola, or a pasta.
